(19) United States
(12) Patent Application Publication
(10) Pub. No.: US 2026/0065715 A1
(43) Pub. Date: Mar. 5, 2026

(54) Biometric Recognition System and Method that Utilizes Multimodal Image Capture with a Single Camera

(71) Applicant: Personavera, LLC, Langhorne, PA (US)

(72) Inventors: Michael Braithwaite, Langhorne, PA (US); Randal Glass, Cherry Hill, NJ (US)

(21) Appl. No.: 19/383,728

(22) Filed: Nov. 9, 2025

Related U.S. Application Data
(63) Continuation-in-part of application No. 18/817,060, filed on Aug. 27, 2024.
(60) Provisional application No. 63/581,452, filed on Sep. 8, 2023.

(51) Int. Cl. G06V 40/70; G06V 10/145; G06V 10/98; G06V 40/10; G06V 40/145; G06V 40/16; G06V 40/18; G06V 40/19

(52) U.S. Cl. CPC G06V 40/70; G06V 10/145; G06V 10/993; G06V 40/117; G06V 40/168; G06V 40/172; G06V 40/19; G06V 40/193; G06V 40/197; G06V 40/145

(57) ABSTRACT

A system and method of identifying a person using images captured from a single camera. The camera is used to image facial features and iris patterns. A person is identified by matching both the facial features and the iris patterns to patterns of previously enrolled people. The images captured by the camera are initially analyzed to sort prime images from obscured images. The prime images are processed to increase the resolution. Facial feature data and the iris pattern data are compared to data in at least one database to match data and identify the person. An illumination system is used that illuminates the person being imaged with infrared or near infrared light. The illumination system is designed to reduce specularities in captured images. The illumination system also enables the light to better penetrate the skin of the hand, if hand vein patterns are imaged.

### RELATED APPLICATIONS

This application is a continuation-in-part of U.S. patent application Ser. No. 18/817,060 filed Aug. 27, 2024 which claims the benefit of Provisional Patent Application No. 63/581,452 filed Sep. 8, 2023.

### BACKGROUND OF THE INVENTION

### 1. Field of the Invention

The present invention relates to identification systems that attempt to identify a person using data collected from an imaging device. More particularly, the present invention relates to identification systems that use data regarding both iris patterns, face geometry, and hand anatomy to securely identify a person while also providing fraud countermeasures.

### 2. Prior Art Description

There are many scenarios in which the identity of a person must be verified. Often, such verification is accomplished using a biometric scan, such as a face recognition scan or an iris pattern scan. However, many existing systems have high False Acceptance Rates (FAR) that limit the usefulness of such systems. In the field of biometric scanning, certain applications require a performance level of FAR<1E-20 for global, errorless identification. Importantly, errorless identification enables absolute de-duplication of records, which is an essential attribute for fraud-proofing every person's identity within an identity authentication system. Automated record de-duplication is a pre-screening operation performed for each enrollment that requires anonymous identity functionality. It is basically a 1:N match of the entire set of existing enrollees to determine if the subject has already been enrolled; it returns a Boolean (true or false). The outcome, therefore, contains no personal details of the subject other than whether he or she already has been enrolled. This feature is enabled by errorless performance and allows complete disassociation of any credential based identifier data that can be laced with fraudulent data. Anonymous, errorless identity serves the ability to use any credentialed identity information and prevents duplicate records. In short, anonymous, errorless identity eliminates all others scheming to masquerade their own identity to fraudulently substitute themselves for accessing the benefits of others. This extraordinary level of ID accuracy requires a system's accuracy to be orders of magnitude greater than the accuracy achieved by typical DNA laboratory tests, which is less than one error in 100 trillion bits matched. Ensuring biometric FAR<1E-20 requires less than 1 error in 100 million-trillion weighted score value of bits matched. Furthermore, setting the minimum threshold for the least score to pass at FARₜₕ<1E-20 forces a shift to the mean of the universal population distribution to approximately FARμ<1E-50. Therefore, the average score must perform to less than one error over one-with-fifty zeros of weighted score value of matched bits. The only reliable way to achieve this level of a false acceptance rate is to scan, analyze and combine multiple biometrics on the same person. This is known in the industry as multimodal biometrics.

Many people have doppelgangers with similar biometric features. Referring to FIG. 1, it can be seen that the when a single biometric feature is used to determine the identity of a person, there is a significant overlap between perceived matches and perceived non-matches. The overlap creates a significant number of false rejects and false acceptances. See FIG. 1. Biometric information is defined as the decrease in uncertainty about the identity of a person by a set of biometric measurements. Referring to FIG. 2 in conjunction with FIG. 1, it can be seen when more than one biometric feature is used to identify a person, the area of overlap between perceived matches and perceived non-matches is greatly reduced by multimodal ID data improved ID certainty. The accuracy of an identification certainty value is equal to 1-uncertainty value. Therefore, preserving consistency with the formal definition above, FIG. 2 graph presents decreasing ID uncertainty values progressing to the right. The benefits of the multimodal matching distribution are indicated by the matching distribution shifting right by many orders of magnitude as compared to FIG. 1. Likewise, the distribution shift then allows the pass threshold to shift rightward. For example, a conventional single iris (si) threshold setting of FARsi<1E-6 changes to Fusion-FAR<1E-20 which is a numerical 1E-14 shift of the pass threshold forcing a reduction of ID uncertainty (i.e., greater ID certainty).

“Big O notation” is a mathematical notation used in computer science to describe the limiting behavior of a function, particularly in the context of algorithm analysis. It provides an upper bound on the growth rate of an algorithm's time or space complexity as the input size (often denoted by ‘n’) grows infinitely large. Accordingly, the Big O notation quantifies how fast a program will run as a function of its data input. The mathematical classification of the ‘Big O Notation’ illustrates the nature of the errorless ID function as it relates to the number of enrollees (N) within the database. Anonymous, errorless ID is only achievable by applying a scaled search over 1:N records, as opposed to 1:1 Verification. As N increases in size, then the errorless FAR threshold (FARth) must increase by one-over-N-squared. For example, a regional database of ten million (N=1E7) requires a threshold set to at least FARth<1E-14, but better set at 1E-15 to guaranteed errorless ID with a margin of safety. A national database of one hundred million (N=1E8) must set the threshold at least FARth<1E-16, but is better set at 1E-17 for errorless ID margin.

Big O Notation denotes a function that tends towards a particular value, and errorless ID threshold shares this as a key attribute. From the exponent perspective, there is a relatively small difference in exponents between the two thresholds of 1E-15 and 1E-20, especially in relationship to the mean FARμ<1E-50. Therefore, FARth<1E-20 is suggested as a universal threshold for any errorless ID database, but could be adjusted depending upon the expected value of N, and as N grows in size.

For example, a fusion-score of facial features and two eye irises has the combined potential at maximum Fusion Biometric Entropy (FBE) to achieve theoretical FAR=1E-172. The breakdown for each iris contributes a maximum FBE potential of 1E-78. Accordingly, the scanned biometric data of two irises doubles the exponent to 1E-156. The scan of facial features produces an FBE potential of 1E-16. The total FBE of all three scanned biometric data is FAR=1E-172.

Biometric performance has been studied and documented by the U.S. National Institute of Standards (NIST). NIST publicly shares data, test results and analysis via their websites including Iris Exchange (IREX) and Face Recognition Vendor Test (FRVT). Information by others, including academics, along with NIST biometric test results, provide highly reliable and accurate performance metrics for large-scale populations exceeding one billion. However, in order for the identification system to be accurate, usable images must be available. NIST has tested, analyzed, and published the performance and rankings of iris algorithms by quantifying both the False Match Rate (FMR) and the False Non-Match Rate (FNMR) relationships, which are associated to algorithm-level induced errors from an existing gallery of captured iris images. Failure Analysis that describes sub-categories of catastrophically failed iris images often fail to progress to the matching process step because they have either failed to crop, segment and/or encode into an iris template. Overall, NIST reported 1.4% of images were classified into a catastrophically non-matching type with the balance (98.6%) succeeding to match with an associated performance FAR score. The principal labels of the non-matching failure categories are referred to as either Failure to Capture or Failure to Acquire (FtC or FtAR).

The US Department of Homeland Security (DHS) has conducted performance testing of selected state-of-the-art biometric systems to determine the full end-to-end performance levels specifically including FtC/FtAR errors. The 2019 Biometric Rally published report of the DHS concluded that the performances of all tested iris acquisition (ACQ) systems were unacceptable because the FtAR failures exceeded their ≤5% performance goal within 5 or 20 seconds of image acquisition. The FtAR results of the tested iris ACQ systems ranged from 212% to 295% depending upon the timeout setting of 5 and 20 seconds. In contrast, NIST reported only 1.4% FNMR for iris problem images. The comparative difference in the two outcomes confirms that the algorithm-level reject errors (FNMR) are a relatively minor contributor to the complete error set quantified by the False Reject Rate (FRR) metric that includes the FtAR rate.

One of the best, yet most complex biometric data sets to obtain is data relating to the iris of a person. The iris is the colored portion of the eye that surrounds the pupil. The iris is not a single monochromatic color. Rather, the iris has a complex pattern of overlapping colors, lines, and speckles and other patterns that extend throughout the iris. Since the iris pattern of an individual is such a good biometric identifier, there have been many prior art systems developed to image the iris of an individual and use that image for identification purposes. Such prior art systems are exemplified by U.S. Pat. No. 5,291,560 to Daugman, entitled, Biometric Personal Identification System Based On Iris Analysis, U.S. Pat. No. 7,277,561 to Shin, entitled Iris Identification, and U.S. Pat. No. 7,796,784 to Kondo, entitled Personal Authentication Method For Certificating Iris. In all such prior art systems, a clear, high resolution image of the iris is required. Such a requirement can present a problem, in that obtaining a high quality image of a person's iris in the real world is very difficult. The iris can be occluded by the eyelids, hair, eyeglasses, or sunglasses. Even if not occluded, there is often too little ambient illumination available or specularities that prevent the capture of the full details of the irises in an image. Off axis angles and setback distances multiply capture challenges beyond viability. Problems are amplified when only one camera is used and the one camera is not specifically centered and focused on the eyes due to positional circumstances or the need to observe other features, such as the appearance or positioning of the face.

Collecting image data for facial features and the two iris patterns can be obtained using multiple cameras, i.e., one or two cameras for each iris and another dedicated camera for the face and is exemplified by U.S. Pat. No. 8,705,808, to Determan, et al, entitled Combined Face and Iris Recognition System. The multi-camera solution enables each camera to have an optimal field of view and corresponding imaging qualities such as resolving power. However, the field of view for the camera imaging the face is optimized for facial biometrics and is much different from the field of view and resolution power needed for the irises. Accordingly, the coordinated use of multiple cameras can present performance problems, which are isolated by the FtAR metric.

Normally attempting multimodal biometric capture using a single conventional Commercial Off The Shelf (COTS) lens produces unacceptably high FtAR levels correlating to Fitt's Law constraints, which quantify human interaction elements. Among other factors, Fitt's Law teaches that the smaller the target, the longer it takes a human to move to satisfy the targeted constraints. Compounding Fitt's Law criteria further, a conventional COTS lens produces a series of additional obstacles including insufficient video frame rate for the live positioning user interface display to avoid counterproductive aliasing effects. This adverse series of impediments causes the FtAR metric to manifest as a single-camera-and-lens candidate design elimination factor attempting multimodal iris and face. In short, one reason many users fail to adequately self-capture their image is that a single camera and conventional lens attributes along with its associated User Interface/User Experience (UI/UX) is far too difficult and slow for attempting combined iris and face biometrics; together the optics and digital challenges compound.

One approach attempting to overcome deficient capture design challenges is to increase the capture volume for improving both proximity and target size. However, an attempt to increase the Field of View (FOV) size by reducing the lens focal length violates immutable iris optical requirements including the Modulation Transfer Function (MTF) and Spatial Frequency (SF). These two iris parameters with their specified values have been shown to be effective for the universal population of irides to fully perform by encoding and matching. Therefore, other means beyond lens focal length reduction is necessary for an exceptionally different approach to achieve multimodal fusion of iris and face by a single camera and lens.

A need therefore exists for an improved multimodal biometrics system that can identify a person using only a single imaging camera, yet provides an extremely high rate of accuracy in a manner that is time efficient, processor friendly, and is both economically and technically reasonable. This need is met by the present invention as described below.

### SUMMARY OF THE INVENTION

The present invention is a system and method of identifying a person using images captured from a single camera. The camera is used to image facial features of a person. The camera is also used to image iris patterns. In a best-case scenario, the person is identified matching both the facial features and the iris patterns of one person by comparing the facial features and the iris patterns to databases of facial features and iris patterns of known people. The facial features and both iris patterns provide multimodal biometric confirmation that far surpasses the accuracy of DNA testing.

The images captured by the camera are initially analyzed to sort usable images from blurred or obscured images. The sorted prime images meet a predetermined image quality that allow data about the targeted biometrics to be obtained. The prime images are processed to increase the resolution of the prime images and create high-resolution images.

Facial feature data and iris pattern data are obtained from the high-resolution images. The facial feature data and the iris pattern data are compared to data in at least one database to match data and identify the person. If facial features and/or the iris pattern(s) cannot be ascertained from the captured images, then a second biometric can be captured by the camera. The secondary biometric can be a hand vein pattern, palm crease pattern, or the like. The secondary biometric can then be added to the multimodal biometrics being analyzed to identify the person being imaged.

A specialized illumination system is used with the imaging camera that illuminates the person being imaged with infrared or near infrared light. The illumination system is designed to reduce specularities in captured images caused by glasses, contact lenses or wet eyes. The illumination system also enables the light to better penetrate the skin of the hand, if hand vein patterns are imaged.

### BRIEF DESCRIPTION OF THE DRAWINGS

For a better understanding of the present invention, reference is made to the following description of exemplary embodiments thereof, considered in conjunction with the accompanying drawings, in which:

FIG. 1 shows a graph that charts ID uncertainty and probability for an identification system that considers only a single biometric parameter;

FIG. 2 shows a graph that charts ID uncertainty and probability for an identification system that considers multiple biometric parameters;

FIG. 3 shows an overview of an identification system imaging a person in the field of view of a camera assembly;

FIG. 4 shows a multimodal biometric data field superimposed over the image of a face;

FIG. 5 shows a multimodal biometric data field superimposed over the image of a hand;

FIG. 6 shows a block logic flow diagram outlining the method of the identification operation post-enrollment for the present invention system;

FIG. 7 shows an exemplary embodiment of the illumination system containing a specialized LED;

FIG. 8 is a cross-sectional view of the specialized LED of FIG. 7; and

FIG. 9 is a diagram that illustrates the conversion of images into a digital biometric template.

### DETAILED DESCRIPTION OF THE DRAWINGS

Although the present invention identification system can be embodied in many ways, the present invention system is particularly well suited for identification systems such as those used in point of sale systems, an Automated Teller Machine (ATM), or a webcam like camera for personal on-line authentication. The exemplary embodiment is selected in order to set forth one of the best modes contemplated for the invention. The illustrated embodiment, however, is merely exemplary and should not be considered a limitation when interpreting the scope of the appended claims.

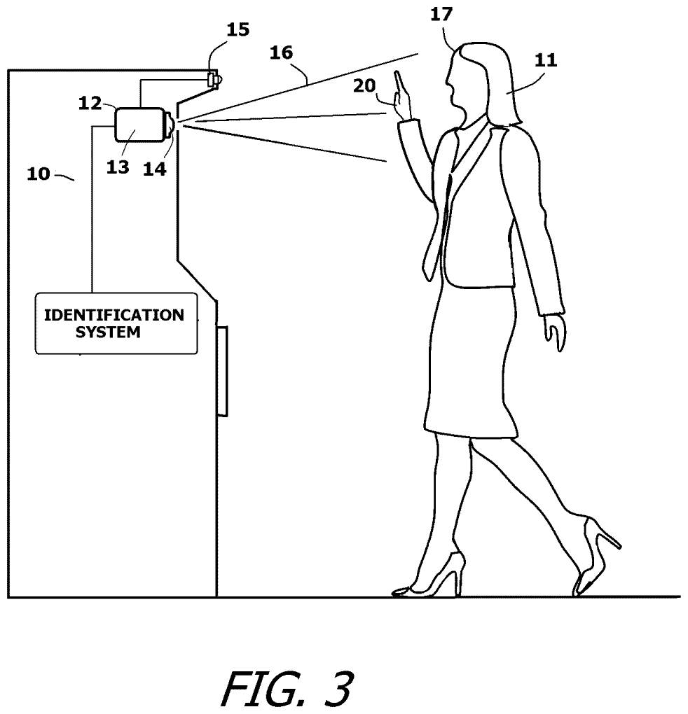

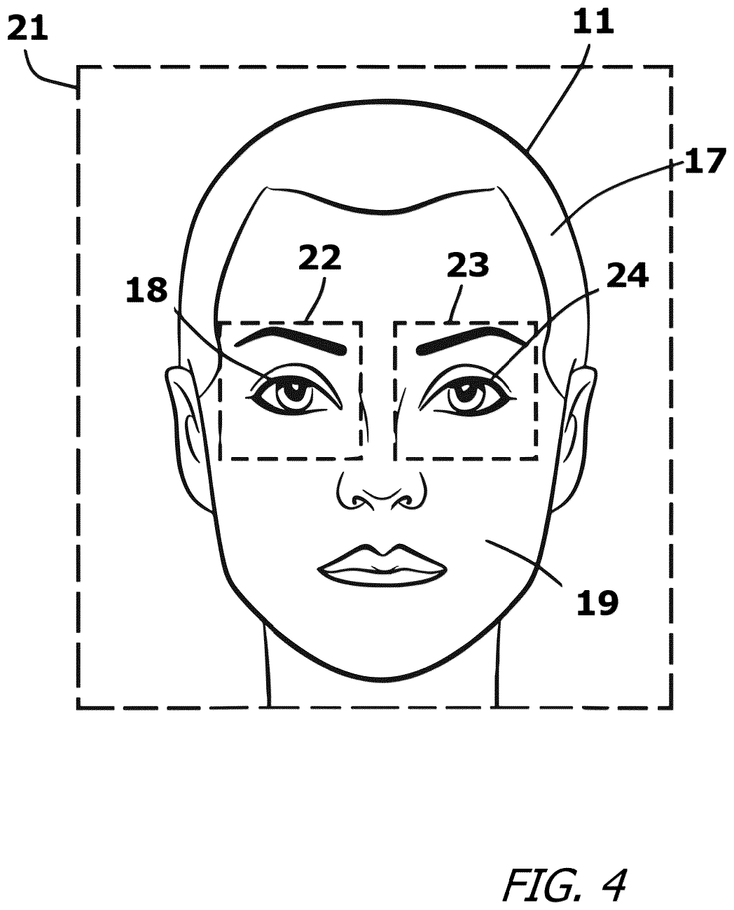

Referring to FIG. 3 in conjunction with FIG. 4, it will be understood that the present invention identification system 10 images and identifies a person 11 as that person 11 comes into range of a camera assembly 12. The camera assembly 12 includes an imaging camera 13 with a fixed focal length imaging lens 14. An illumination system 15 is also provided for illuminating the person 11 as the imaging camera 13 is in operation. The illumination system 15 can be part of the overall camera assembly 12, or can be separate and distinct from the camera assembly 12. The person 11 being identified can stand or sit in front of the camera assembly 12, such as when standing in front of a bank machine, a point-of-sale panel, or a personal computer. In any such scenario, a single imaging camera 13 is used. The camera assembly 12 has a field of view 16 sufficient to image the head 17 of the person 11 at a selected working distance. The head 17 is imaged in an attempt to capture both the facial features 19 and the iris patterns 18 of the person 11. In addition to the head 17, the camera assembly 12 is also capable of imaging the hand 20 of the person 11, if that hand 20 is raised into the field of view 16.

Preferably, the field of view 16 of the camera assembly 12 captures a sufficiently large imaging field 21 that can encompass the overall facial features 19 or hand 20 of the person 11 and two smaller imaging fields 22, 23 for the eyes 24. The large imaging field 21 used to capture the facial features 19 must have enough area and detail to discern the shape of the face and the positions of various points on and around the eyes 24, nose, and mouth. The imaging fields 22, 23 for the eyes 24 are smaller but must contain enough detail to map the iris patterns 18 in at least one of the eyes 24, and preferably both of the eyes 24. The resolution needed in the imaging fields 22, 23 for the eyes 24 is greater than that needed in the large imaging field 21 for the facial features 19. If done accurately, combined imaging fields 21, 22, 23 for the overall facial features 17 and two eyes 24 provides the three sets of biometric data needed to achieve the FARₜₕ<1E-20 accuracy level required for the identification system 10.

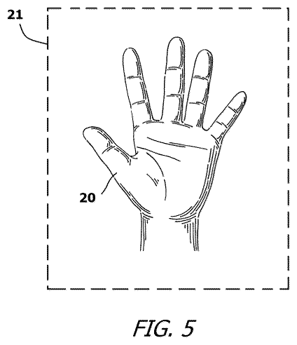

It will be understood that if the person is wearing glasses, contacts, heavy makeup, facial hair or the like, data available one or more of the imaging fields 21, 22, 23 may be incomplete. The identification system 10 can image other aspects of the person 11, if brought into the field of view 16 of the imaging camera 13. Referring to FIG. 5 in conjunction with FIG. 3, it can be seen that the hand 20 of the person 11 can be raised toward the imaging camera 13. The hand 20 is smaller than the head 17 and will fit in the imaging field 21 of the head 17. By imaging the hand 20 with the proper near infrared illumination from the illumination system 15, features such as hand geometry, and subcutaneous palm vein patterns can be captured by imaging camera 13.

Referring to FIG. 3, FIG. 4, and FIG. 5 together, it will be understood that one camera assembly 12 is used to collect data from all the imaging fields 21, 22, 23. One camera with a fixed focal length lens can only have one field of view. It will therefore be understood that when viewed from an electro-optics design perspective, the imaging of the facial features 19, the imaging of the hand 20, and the imaging of the iris patterns 18 will have different optical requirements for the field of view. This creates a resolution conflict with the optimal focal length settings for the imaging lens 14 used in the camera assembly 12. Facial features 19 and features of the head 17 in the large imaging field 21 require relatively low resolution that is optimized by a lower focal length lens with a wider field of view. Furthermore, iris patterns 18 imaged in the smaller imaging fields 22, 22 require higher resolution by a higher focal length lens with a corresponding narrower field of view. These opposing requirements matter greatly in the design of the imaging lens 14. Imaging facial features 19 and/or the hand 20 requires a large field of view 16, indicated by the large imaging field 21, to fully envelop all the facial features 19 of the person 11. The same large field of view 16 is used to image the hand 20. The hand 20 may appear smaller to the imaging camera 13 than is the head 17, but the hand 20 is closer. Accordingly, a small focal length works best. Conversely, capturing the miniature iris patterns 18 requires a small field of view by a longer focal length lens.

The identification of iris patterns 18 from an image requires a spatial frequency of greater than 15.7 pixels/mm and an optical modulation transfer function of greater than fifty percent contrast, 2 lp/mm at the plane of the iris. The modulation transfer function in object space is a constant value. However, successful capture of the iris patterns 18 must accommodate the range of distances between the imaging camera 13 and the person 11 being imaged. Therefore, the modulation transfer function constant value in object space must be translated to the modulation transfer function at the image plane by applying the following governing equations over a working distance (WD) and lens focal length values for the imaging lens 14.

$$Image space MTF is ( lp / mm ) = \frac{Object space MTF ( lp / mm )}{PMAG}$$

PMAG is Primary Magnification, where negative polarity means the image is inverted.
MTF is the Modulation Transfer Function.

$$PMAG = - ( 1 / ( FL - 1 / WD ) ) / WD .$$

$$PMAG = sensor size ( mm ) / Field of View ( mm ) ,$$

where
FL is the lens Focal Length (mm).
WD is Working Distance (mm) from the imaging lens to the object and,
lp denotes line-pair pitch/spacing of a black-and-white optical target.

A traditional MTF graph plots MTF in relation to special frequency. A traditional MTF graph starts at 1 and slopes down as the graph progresses, which means that modulation or contrast is decreasing as spatial frequency increases. It will be understood that for a camera and lens system to comply with the specified iris modulation transfer function (MTF) equated at the image plane, the power of magnification must be increased in proportion with an increase in the working distance. For a working distance of 24″ (610 mm), the MTF object plane requirement of ≥50% contrast at 2 lp/mm converts to 97.6 lp/mm at the image plane. For lens design computation-input purposes, 850 nm is used as the central wavelength as 850 nm is known as the optimum iris near-infrared wavelength. The lens inherently includes an aperture that must avoid encroachment of the diffraction limit that could potentially impact the ≥50% contrast at the targeted MTF spatial frequency point, corresponding to the highest WD value (at the longest user distance). The MTF is also a performance attribute of the lens f/# selected. Commercially available lens design systems are used to complete predicted MTF curves of an imaging lens system typically comprised of multiple elements. Nevertheless, the equations provided above are a reliable predictor of the minimum design focal length in order to comply with the iris MTF requirement while capturing out to the longest distance. For example, at WD=24 inches, a lens with focal length of at least 11 mm is a computer input candidate value that could potentially comply with the iris MTF requirements. Alternatively, another perspective is stated oppositely that any lens design with a focal length less than 11 mm cannot possibly be designed to comply with the iris MTF requirements beyond 24″. Notable is that the 11 mm FL lens provides a sufficiently large FOV for imaging the whole face too, enabling the potential for multibiometric capture, if not for other more vexing design obstacles.

Once the MTF values are satisfied by a candidate lens design, there is also a need to satisfy the spatial frequency (SF) iris requirement. While the MTF is substantially determined by the performance of the lens design, the selected sensor attributes substantially contribute to the SF outcome. Distinguishing the differences of SF from MTF can be understood in terms of information transfer to a receiver. At very low spatial frequencies, nearly all of the information gets transferred by the lens from the object being viewed to the camera pixels. i.e., the MTF is 1 (100% transfer). At high spatial frequencies (extremely fine details), the MTF drops to 0 (0% transfer), which means that no information is being transferred to the pixels by the lens. The MTF curves connects the two points for all frequencies between the polar extremes. In addition to the amount or quality of information transferred by the lens, the receiver of that information must be considered. An example receiver analogy is the Aerial Image Modulation (AIM) curve, typically applied to understanding the performance of the human eye from a system perspective including consideration of the retina's rods and cones (receivers). For pixels, the AIM curve at very low spatial frequencies, no information is lost. At the Nyquist Frequency (500 divided by the pixel width in microns), 36% [1−sin(π/2)/(π/2)] of the information is lost or modulated, and at twice the Nyquist Frequency (NF), all information is lost, regardless of the lens performance. In the frequency domain beyond the NF, destructive aliasing effects worsen, complicated and compounded by anti-aliasing filters that induce latency. But optical aliasing for examples herein occurs at the frequency domain well beyond an SF value raising any concern. Therefore, SF induced optical aliasing is avoided and thus ignored herein.

Designing the camera by sensor selection and lens to solely meet the iris SF requirement becomes counterproductive to Fitt's Law because compliance with a high value SF can substantially limit the FOV size, or capture target size. Compounding and amplifying the Fitt's Law problem to a worse degree, attempting to solve or satisfy the iris SF requirement with a larger sensor array, causes a significant data transfer throughput problem effectively choking and aliasing the UI/UX because the frame rate feed to the UI/UX is much too slow. This optical SF and FOV relationship establishes that meeting high SF values for iris affects the UI/UX and ultimately impacts the capture time, which becomes dispositive eliminating an otherwise viable potential single and lens camera design. An example of an unacceptable low data transfer time for a 20-megapixel sensor full frame (20 MP monochrome*8 bits) is limited to 2˜3 frames per second using a USB-C Superspeed (SS) capability. This data transfer bottleneck is multiples too slow and ineffective even at the very best/highest possible SuperSpeed data transfer rates.

The incompatibility of high SF and low data transfer rate must both be solved for a single camera and lens to be a viable capture platform for both iris and face multibiometrics, thus eliminating this unattainable design preference. Overcoming additional technical design obstacles are discussed further.

The preferred camera assembly 12 includes the embedded capability to perform a 4× binning operation, which averages the values from four adjacent pixels. Thereby, binning reduces the full frame output size by 4×, which likewise decreases the transfer time per data packet by 4×. 4× binning solves the UI/UX aliasing by a faster frame rate, if it were not for the decimation of the SF that fails the required iris SF minimum. To examine the binning operation further in context exploring potential harmony with the iris SF requirement, it is useful to examine the Nyquist Frequency (NF). The Nyquist Frequency is the theoretical maximum frequency a digital system can capture and represent a continuous signal. As a real-world sensor example, a square pixel dimension of 1.4 microns is used to calculate the example's NF. The Nyquist Frequency in this example computes to 357 lp/mm (500/1.4 μm). The 2× sample rate of this example lens-sensor pair where all useful signal information diminishes to zero is 714 lp/mm (2*357 lp/mm). Therefore, the actual pre-binned SF appears to be sufficiently oversampled as compared to the lower MTF value from the optical signal supplied to the pixels (97.6 lp/mm, >50% contrast). For this real-world example, pre-binned SF pixel oversampling of the iris pattern imaged signals causes very little signal attenuation beyond the MTF signal modulation effects due to the optics alone. This oversampling attribute provides a potential latent opportunity to be exploited, which has previously eluded multimodal biometric camera designs.

Summarizing, 4× binning on the sensor post full frame capture satisfies the transfer rate and UI/UX aliasing challenge. The binned output rate becomes sufficiently fast to present a refresh rate to the user real-time at 15 or 20 fps as only a low-resolution face is needed for UI/UX display and user positioning. However, the post-binned SF becomes unacceptably low and non-compliant SF for iris processing. Yet, the electronic signals encoded in the pixel values were originally at fully compliant SF, pre-binned pixel registers. There exists a process to substantially recover the original, compliant SF post binning with little signal loss and possibly benefit contrast enhancement, though limited in degree of improvement. This means the original fine detail iris pattern signals recover substantially by applying the digital recovery process.

The digital recovery process applied is herein referred to as Super Resolution upscaling. Super Resolution upscaling increases the number of pixels in the images, transforming it from a lower resolution to a higher resolution. Topical descriptions, algorithms and supporting materials have been publicly available in recent years about the Super Resolution upscaling process. Digital image data does not necessarily need to be over-sampled a-priori for Super Resolution to produce benefits. However, Super Resolution research shows that it is particularly effective for the case of digital signal recovery of an original, high digital quality image; and vice-versa effects for original low quality image signals may not benefit and can worsen image quality. The 4× binning also improves an inherent pixel noise error, which is referred to as dark noise. The 4× binning reduces pixel noise by 2× (SQRT 4), which doubles the image's composite signal-to-noise ratio (S/n). Doubling the S/n causes an outsized benefit for the finest of iris pattern signals toward the highest frequency band as those signal levels are least, which pre-binned noise effects have the most benefit.

Facilitating multimodal biometrics in high resolution with a large FOV for whole face capture, then 4× binned before transmission, the 4× Super Resolution upscaling process applied is highly effective because the fine pattern/high-frequency signals are most universally abundant iris patterns. The Super Resolution upscaling produces strong iris encoding and matching performance, as if higher optical magnification (a previously known enhancement method) were originally applied.

A third benefit of the Super Resolution process is its effects on diffraction. The diffraction limit (DL) where the 50% contrast point occurs is calculated as follows: DL (lp/mm)=(1000/(f/#* lambda))*0.4, where lambda is wavelength of light in microns. Thus, higher wavelength bands such as near infrared (NIR) at 0.850 μm cause greater diffraction effects than visible light, such as the DL visible band DL wavelength mid-point at 0.550 μm. The diffraction limit is sometimes described and regarded as a distinct line that cannot be crossed, else substantial if not total information destruction occurs. However, the diffraction limit is not a line of demarcation between binary domains of useful versus useless information signals. Instead, the diffraction limit marks the beginning of a transition from sharp to blurry, as the affected higher frequency bands are viewed or analyzed. Despite the Airy Disk corruption effects initiating at the DL, some useful, residual and diminishing signals remain beyond the diffraction limit. Super Resolution upscaling extends the diffraction limit, which is another welcome benefit for iris imaging constrained by the adverse diffraction effects of the 850 nm (0.850 μm) wavelength of light. Super Resolution upscaling is reported to recover a tangible amount of useful signals before growing image quality information destruction occurs by diffraction effects that eventually and hopelessly blurs fine patterns at ever higher frequencies.

The combined effects of binning and Super Resolution solve the iris MTF and SF challenge, though within the limits of Physics and optics as previously discussed (i.e., focal length minimum and maximum working distance still apply). Confirmed iris performance results from the capture and Super Resolution quality recovery sequence are unambiguous. Together, as a novel introduction, they enable dual-iris and face multibiometrics using the imaging lens 14, which is a conventional, low distortion, fixed focal length lens. The single imaging camera 13 with its conventional imaging lens 14 fully perform to replace multiple cameras and lenses for face and dual-iris biometrics. Additionally, it spawns other benefits.

### Combining Multiple Biometrics:

The differential math for determining the Fusion False Accept Rate (F-FAR) and Fusion False Reject Rate (F-FRR) for various data sets is known. Generally, combining the differential AND-process related to component-level false positives multiply while component-level AND-process false negatives are an additive to the fusion outcome. Combining biometrics by the OR-process flip-flops the math to multiply the false negatives and add the false positives. While biometric fusion math equations are surely necessary to compute an outcome, the fusion math requires known performance characteristic input values of each component biometric. That is, biometric component values at or near realistic operating points are required to accurately compute fusion results. NIST has published both small and large-scale face and iris performance values and plotted curves. NIST applies nomenclatures to distinguish performance features. NIST reports use FPMR and FNMR acronyms for False Positive/Negative Match Rate that correlate and apply to smaller scale population sizes using 1:1 matching (i.e., Verification with an ID-index asserted). FPIR and FNIR are intentionally different acronyms used to distinguish False Positive/Negative Identification Rate that apply to large scale population sizes using 1:N, or 1:many matching (i.e., 1:N is anonymous identification without any index assertion). However, NIST abridges some of their plotted graphic FPIR iris performance data, which is especially challenging as iris data truncation at too low of values withholds key iris component values needed for fusion computation. In comparison, a visa image facial performance provides full scale FNIR beyond 30% revealing a vast FPIR data range that provides the full data relationships of the facial error tradeoffs. Yet, by surprising comparison for iris identification cuts off the best performing algorithms' data near FPIR˜1E-4 and FNIR<1%. Key iris performance data is not presented graphically. This desolate data truncation of meaningful iris performance beyond FPIR<1E-4 appears as an iris component data blackout for high performance iris systems, if reliable data cannot be determined by some alternate means. However, more obscure means are provided by NIST and described later in full context of supporting high performance iris for large scale, errorless identification.

### Individual Biometric Entropy:

The iris patterns 18 are randomly formed by an epigenetic process (i.e., not DNA related) in the third trimester of development called chaotic morphogenesis, which is a random ripping of the iris tissues that remain stable throughout life. Everyone presents their own degree of biometric entropy, especially for iris patterns 18. The biometric entropy randomness for irises over a large population is Gaussian and is circumscribed by a bell-shaped curve. Therefore, about half of the population has naturally favorable personal iris biometric entropy while the other half tends towards lower than average. Because the average biometric entropy for the irises is well beyond what is required for successful errorless ID (FARth<1E-20), then a high majority of individuals present ideal dual-iris patterns that can help to compensate for other performance-degrading factors, such as eyelid occlusion, eyeglass obstructions and eyeglass specularities. Accordingly, most of the population present well for ideal image capture success with little or no need for repeated image capture attempts.

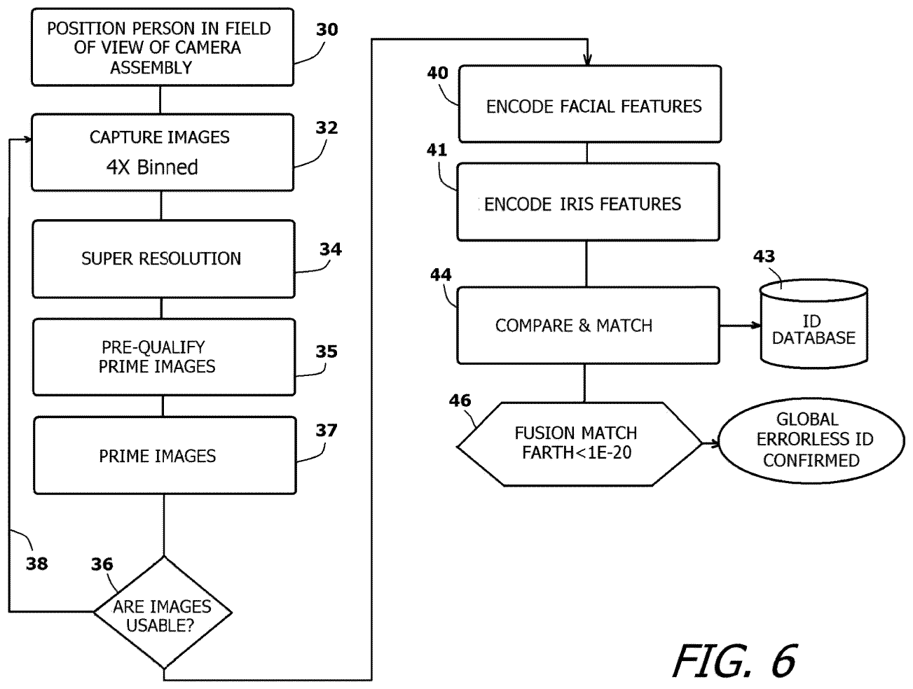

Referring to FIG. 6 in conjunction with FIG. 3, FIG. 4, and FIG. 5, it can be seen that the first step of the present invention identification system 10 is to provide a camera assembly 12 with a single imaging camera 13 and an fixed focal length imaging lens 14. See Block 30. The selection of the imaging lens 14 depends upon the working distance between the imaging lens 14 and the aspect of the person 11 to be imaged. The selection of the imaging lens 14 also depends upon the required field of view 16. The illumination system 15 is positioned to illuminate the person 11 when the person 11 is in the field of view. Once the camera assembly 12 and the illumination system 15 are activated, the person 11 is imaged. The images are taken in high resolution with a large FOV for whole face capture, then 4× binned before transmission. See Block 32.

Once images are obtained, the images are subjected to Super Resolution upscaling to increase the number of pixels in the images. This transforms the lower resolution images to higher resolution images See Block 34.

The higher resolution images are pre-qualified. See Block 35. During prequalification, the images are initially analyzed to see if the image has a high likelihood of containing the information needed for further processing. For the head 17 and/or the hand 20 the large imaging field for each image is scanned to see if the head 17 or the hand 20 is properly oriented relative to the imaging camera 13. If an image of the full head or full hand is askew, obstructed, blurred or otherwise out of focus, that image can be discarded from further analysis. Images of the head 17 are further initially analyzed by scanning the enlarged imaging fields 20, 21 for the eyes 24. Multiple iris quality metrics are then dynamically applied to quickly evaluate and differentiate an ideal image from lesser quality images. Images occluded by eyelid position, hair or specularities are discarded. The iris quality metrics processes operate faster than frame rate causing no adverse impact to the UI/UX because quality metric operations are essentially transparent. Images that are evaluated to be substandard or non-ideal for both irises are promptly rejected, and the process continues. This cherry-picking process is used to find prime images, wherein prime images contain enough usable data that further analysis warranted. See Block 36, Block 37 and loop line 38.

After presorting, a series of usable prime images are collected. See Block 37. The sorted prime images are encoded. The encoded data contains information on the facial features 19 and the iris patterns 18. The encoded data can be compared to known people in one or more databases 43. See Block 40, Block 41, and Block 44.

When the images are improved and prequalified to obtain prime images, as shown in Block 34, Block 35 and Block 37, the results can be improved by implementing a Bernoulli distribution sequence repeatedly, as needed. The outcome from a Bernoulli distribution is estimated using Equation 1 below, which is a binomial probability calculation that quantifies the effects of multiple trials, or subsequent image retries especially seeking to capture high quality images for head 17, iris pattens 18 and hand 20 if needed.

### Equation 1—Binomial Distribution Formula:

$$P ( x : n , p ) = n ! / [ x ! ( n - x ) ! ] * {p}^{x} * {( q )}^{n - x}$$

where,
n=the number of trials, or samples
x=the number of successes desired (in this case x=1)
p=probability of success in one trial
q=1−p=probability of a failure of one trial
   Using the example of processing an image of the iris patterns 18, the processing starts with a low probability image with a numerical value of 58% dual-iris, singular image success rate due to the combination of many dynamic factors at play including the occasional eyelid occlusion. Using the 58% value for a single image dual-iris image capture success rate (p=0.58), the estimate for final success P (x:n, p) after seven retries exceeds 99.7%. Applying the same sequence theme in combination with more than seven frames asymptotically approaches 100% within every session for everyone. Therefore, iris quality metrics supporting a realistic full-frame rate of 15-20 fps, for example, provides high assurance that ideal dual-irises will be selected in less than a few seconds after a cooperative user positions themself into the field of view 16 for the camera assembly 12.

NIST IREX reports presents iris test results for many algorithms mostly including randomly selected iris inputs. However, generally, NIST IREX studies have not disclosed the effects of cherry-picking a more qualified iris over a randomly selected iris. For example, one iris image candidate can reveal slightly more iris area by presenting less eyelid occlusion than the same iris imaged just a moment before. Therefore, real-time culling or cherry-picking a preferred iris input over the random iris produces an improved ID uncertainty expressed as FPIR or FAR values for each selected iris. Furthermore, careful culling of a highly preferred iris for enrollment that later compares to all other irides for future matching amplifies all subsequent fresh iris probe FPIR/FAR performance results. The net effects of culling a preferred iris over a random iris benefit twice: once for enrollment and another for matching future iris probes. While a comprehensive large-scale study quantifying the beneficial effects of culling preferred irides is not known to exist, internal test results confirm highly significant improvements in individual iris FAR results for both enrollment and subsequent probes. Preselecting a preferred iris performs to a significantly better match level than a randomly selected iris, which the Quality Metrics promptly curate in real-time. Per ISO/IEC 29794-6, entitled “Information Technology-Biometric sample quality, Part 6, Iris Image Quality” there are more than a dozen specific QMs that provide some measure of performance correlation for predicting the encoding and matching process success rate, each with their own correlation value. NIST IREX II efforts published in 2011 sorted out the most useful QMs and USABLE IRIS AREA was reported as the best predictor of iris matching success. NIST 2011 Interagency Report 7820, entitled “Iris Quality Calibration and Evaluation, Performance of Iris Quality Assessment Algorithms”, states, “the difference between FNMR of images with the lowest USABLE IRIS AREA and the highest USABLE IRIS AREA can be as large as two orders of magnitude.” Special emphasis here highlights the FNMR metric quoted, which is now related to its corresponding FPMR metric exploding benefits by many more orders of magnitude. NISTIR 8207 published in 2018 presents test results of matching random irides using various algorithms. For a large majority of iris algorithms, the curve's flatness, or very low slope of iris FNIR versus FPIR is highly evident. Accordingly, NIST 8207, One to Many Matching, Notable Observations, Flatness Section on page 15 highlights the low changing slopes of iris performance. NIST's delta-X (FPIR) and delta-Y (FNIR) slope value change of 0.001 over three FPIR-decades calculate to +0.0003 increase in FNIR for each order of magnitude (decade) decrease in FPIR. Thus, NIST's large-scale results producing very low changing iris performance slope confirms that ten orders of magnitude FPIR improvement come at the tradeoff “expense” of 0.003 increase of FNIR: a substantially negligible operational tradeoff. Extrapolating the best performance curves using NIST stated iris slope value, a single iris matched pair produces FPIR˜1E-14 at FNIR˜0.01, not including the benefits of real-time pre-selecting/culling. In summary, despite NIST presentation data blackout for their plotted iris performance curves, high confidence is assured using component-level test data to extrapolate that a very small improvement in iris presentation including unobstructed USABLE IRIS AREA correlates to astronomic improvements in FPIR and FAR values corresponding to an imperceptible erosion of FNIR, or FRR.

### Multibiometric Fusion

Pre-selecting a preferred iris produces a very large improvement in iris matching performance with compounding effects. A small test sample set QM culling and preselecting produces FPIR exponent near-doubling effects for each of the improved enrolled-iris and nearly doubles the FPIR exponent again for the iris-probe match. In summary, the compounding improvement to iris performance alone, not including multimodal face, anecdotally by small sample testing has been observed to typically produce FPIR<1E-24 for each iris captured in less than two seconds. Combining dual-eye plus face multimodal fusion suggests the mean Fusion-FARμ<1E-50 is a likely accurate prediction across the universal population of 7 billion.

One naturally difficult aspect for characterizing singular, component biometrics dictates large scale testing in order to establish component FPIR/FAR and FNIR/FRR statistical values for use in estimating performance over larger populations. Notably, two biometric terms of merit are highly diverse in its tested characteristics. At operational points of interest, a very high percentage (>98%) of tested individuals produce a corresponding FPIR value, while a very small percentage (<2%) produce a corresponding FNIR value. Aggravating this original difficulty to determine and supply an adequate test-sample size related to producing reliable tradeoff statistics, the FtAR is a significant test process spoiler. Failure-to-Acquire stops the testing process at the start before useful data can be collected. NIST and others have eventually overcome a multitude of challenges to collect, analyze, and publish reliable performance statistics for three biometrics, namely face, fingerprint and iris. All other biometrics, including tongue, ears, and hand-vein, NIST categorizes as “experimental,” which if predictable will take years to complete validation tests, once a new candidate is elected. Since NIST has taken almost two decades to complete the accurate, large-scale statistics of three component biometrics, one could ask does multibiometric fusion require a similar non-trivial time and effort to complete and publish validation results establishing reliable, large scale fusion performance curves?

Consideration of the multimodal fusion biometrics' validation question raises two important points that are highly unlike establishing the previous statistics of the three component biometrics. Firstly, fusion statistics are far easier and quicker to test, especially with near-zero FtAR sample collection (non-interference) as the opportunity to produce a non-zero score is increased by 3×, by using three biometrics. Secondly, establishing that a Fusion-FARμ value point at its corresponding <1% FRR, essentially seeks to measure the shifted value of the previously established component distributions (iris and face), i.e., the entire component distribution does not need to be reestablished but rather determine the shifted value to F-FARμ only. Furthermore, shift measurements become strictly academic when results extend beyond a predicted ID uncertainty point. Global Errorless ID is assured by applying a pass threshold of FARₜₕ<10E-20, i.e., doppelgangers are extremely unlikely to occur beyond the threshold with the impostor probability curve sloping exponentially downward. Once sufficiently few negative 3-sigma individual iris “goats” that are characteristically poor iris presenters and performers in reference to Doddington's “On Hunting Animals of the Biometric Menagerie for Online Signature “are shown to pass with margin, statistical confidence grows quickly by a remarkably small sample set. In fact, any of the seven known iris characters from Doddington Zoo can contribute significantly by their delta-test-results difference of a single iris FAR as compared to their Fusion-FAR test results. Therefore, test, validation, and verification producing reliable fusion statistics for large populations are promptly determined by an unusually small sample set of selected individuals to predict the universal Authentics Fusion distribution by Fusion-FARμ & Fusion-σ. Internal test results of iris matches confirm that theory and practice match consistently within a 1-4 second capture window. Confirming the fast capture time window is also an important metric of merit corroborating the whole suite of contributing metrics for time-to-target-UI/UX, frame rate, optical and digital qualities, QM pre-selection, and Binomial Distribution theories. Those toward the slower capture window at 3˜4 seconds are fully explained too as mostly those wearing eyeglasses, which is yet another substantial design challenge to solve the iris-plus-face fusion biometric maze by a miniaturized device.

### Data Integrity

The iris-specific quality metrics have overlap with similar facial quality metrics. For example, the sharpness score at the iris location of the image shares a great deal in common with the whole image. Some iris quality metrics can substitute and adequately service some facial quality metrics, therein avoiding process duplication or other optimizations such as parallel sharpness evaluation. Additionally, data quality analysis is also related to data integrity analysis, especially to thwart threats to data integrity.

Biometric counterfeit substitutes, such as a facial picture, video or face mask that are designed to mimic an actual user's biometric features are a security threat to a biometric identity system. For a security check against counterfeits, Presentation Attack Detection (PAD) methodologies and protocols are used to distinguish a counterfeit substitute from an authentic user. Yet, the fusion FARₜₕ<1E-20 pass-threshold utilized by the identification system 10 also operates to detect and reject inferior quality counterfeits for each component-level and the aggregated effects of counterfeit inferiorities, while also achieving errorless ID.

As indicated by Block 40 and Block 41, the facial features 19 and iris patterns 18 are encoded into three component templates 71, 72 and 73. The encoded information is compared to ID databases 43 to find any matches. See Block 46. The biometric check of facial features 19 and both iris patterns 18 also act as a counterfeit check. Given that the correct index is guaranteed during exhaustive iris search at speeds up to one billion per second, the additive False Non-Match Rate (FNMR, 1:1 match) of a legitimate face record failing to confirm is very small at 0.0001 per FRVT, 1:1 (i.e., lower performance 1:N face is avoided). Given the candidate index by the first searched iris yields an average FPIR<1E-24, or a minimum of FPIR<1E-14 as explained previously, then the combined minimum FPIR with only one-eye plus face yields FPIR<1E-19. This ensures all but a few legitimate users pass the global threshold by one face and only a single eye matching. This very small error rate yields the same mean errorless confidence of F-FPIRμ=<1E-50 (all three components) that each of the other biometrics indeed are a correct match to themselves as well as to the correct ID record (index). The inherent full integrity of a single biometric image better realizes idempotent results with increased security that competing systems with separate images for each biometric fails to match without a chain-of-custody. A single biometric image offers security enhancement potential that thwarts the assembly of images acceptance challenge. PAD processes would otherwise need to verify a mosaic of stitched-together images from multiple shots for cameras that cannot produce an immutable process for source data integrity. Furthermore, a Doddington factor can be applied that characterizes the expected quality of individuals iris performance that is used to establish a personalized counterfeit PAD pass result to an even higher standard. For example, as the multibiometric system's repeated use of any individual indicates their fusion performance is mostly positive-sigma (i.e., typical FAR<<1E-50), then a specific PAD countermeasure threshold can be modified to tighter PAD criterion, e.g., PAD-FARₜₕ<1E-30, or <1E-40.

Attempted counterfeit iris must contend with the original surreptitious capture of irides that are not on-axis and at farther distances, which amplifies geometric difficulty itself (ref. iris optical requirements) but also is presented within a set of moving and rotating head and eyes covered by the reflective visible-light cornea and poor iris tissue reflectivity within the visible band. Visible light iris performs much worse than with NIR light iris. If the combined counterfeit quality challenge is not already secure enough attempting to pass the high-hurdle of PAD-FARₜₕ<1E-20, then one additional function can be optionally added operationally to the inherent suite of capabilities.

In some less common situations, there may not be an adequate image collected for the full face or the iris pattern(s). This may be due to a combination of hair style, a medical face mask, or niqab, smudged eyeglasses or the like. In such a situation, there are no longer multiple biometric data sets available for identification processing. In such a scenario, other biometric features can be used as a substitute for face identification or iris identification, or PAD. Since the identification system 10 of the present invention uses a single camera assembly to collect images from a person 11 in the field of view 16, one of the simplest images to collect is that of the person's hand 20. The person 11 in front of the camera assembly 12 can be prompted to raise his/her hand 20. The hand 20 can then be imaged. The hand contains various biometric features that can be readily imaged. Among the biometric features are hand geometry and subcutaneous palm veins. The camera assembly 12, imaging lens 14 and illumination system 15 can capture such biometric features. The human hand readily fits within the field of view and the illumination system 15. The illumination system 15 can use near infrared light. When the hand 20 is illuminated, the near infrared light reveals and distinguishes subcutaneous veins in the captured hand image. If hand-vein biometric performance does not extend beyond 1:1 or 1:few accuracy, it is still completely sufficient as an additional PAD countermeasure presenting either or both hands initiated by a display prompt. Similar to the many difficulties attempting surreptitious iris capture, surreptitious flat, open hand image capture of another's hidden palm veins are vexing challenges of substantial magnitude. At some incredulous point, counterfeiting simply becomes implausible. It requires attempting multiple high resolution surreptitious captures, then hazarding artificial and accurate reconstructions of various different human tissues responding to NIR and then presenting life-like responses of sequential presentations with a series of sufficiently high-quality counterfeit biometrics, all within a few seconds. Taken together the multiplex of countermeasures reduce the combined efficacy of attempted counterfeit biometrics to an implausible practice.

Errorless identification is achieved if a match is found for the facial features 19 and both iris patterns 18. See Block 46. The same camera assembly 12 can also provide a user interface video stream further simplifying user feedback for speedy multimodal biometric image evaluation and capture of an ideal image associated with lowest FRR. Intelligent image capture of all three biometrics using a single device for errorless identification produces an ideal iris image with inherent properties with multiple uses and benefits including protecting against ID fraud and ID theft. If the facial and iris features are insufficient, the hand features can be used in place of facial features 19 or an iris pattern 18.

### Capturing Iris Images Through Eyeglasses

The most common obstacle to obtaining a usable image of a person's iris is the presence of eyeglasses. Eyeglasses cause iris imaging and performance impacts by two distinct types of degradation. One type is iris imaging quality effects due to dirt, dust, fingerprints, smudges, scratches, or any type of surface contamination to either or both front or rear eyeglass surfaces. These real-life operating optical effects are factored into the prior iris performance discussions explained above. However, it is worth noting that the cohort wearing dirty and scratched eyeglasses causes a finite shift leftward within the Authentics curve toward the lesser ID certainty direction as compared to one's individual standing as a Doddington iris animal, not wearing eyeglasses. The second impact is the iris image and performance degradation by obstruction of the iris from illumination specularities, again from either or both, first or second eyeglass surfaces. Eyeglass specularities are typically self-induced by the capture camera's own supplied illumination. U.S. Pat. No. 6,055,322 to Hanna and Salganicoff entitled, “Method and apparatus for illuminating and imaging eyes through eyeglasses using multiple sources of illumination” first taught a twelve degree angular offset to avoid destructive eyeglass specularities obscuring the iris. A further refinement, US Patent Application 2003/0169334 A1, by Braithwaite et al entitled “Iris Capture Device having Expanded Capture Volume” published how a more compact iris capture device can use an alternating cross-illumination scheme to avoid causing specularity obstructions on eyeglasses to either iris. Over the vision correction range of eyeglass diopters, 11.3 degrees is the precise angle that causes all resultant specularities to appear just tangent or outboard of the iris diameter boundary, or beyond. This angle ensures no specularity portions cause iris obstruction. A different approach to solve the eyeglass specularity challenge is published in U.S. Pat. No. 6,540,392 to Braithwaite entitled, “Micro-illuminator for use with image recognition system”. This novel approach leverages a smaller illuminator source solid angle that produces proportionally smaller eyeglass specularities causing lesser, but possibly tolerable, iris image obscuration with reduced performance impact, as opposed to elimination.

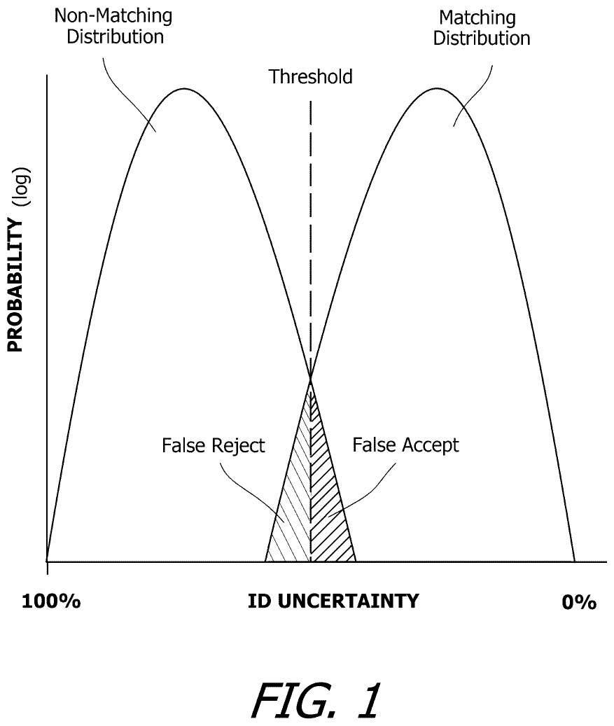

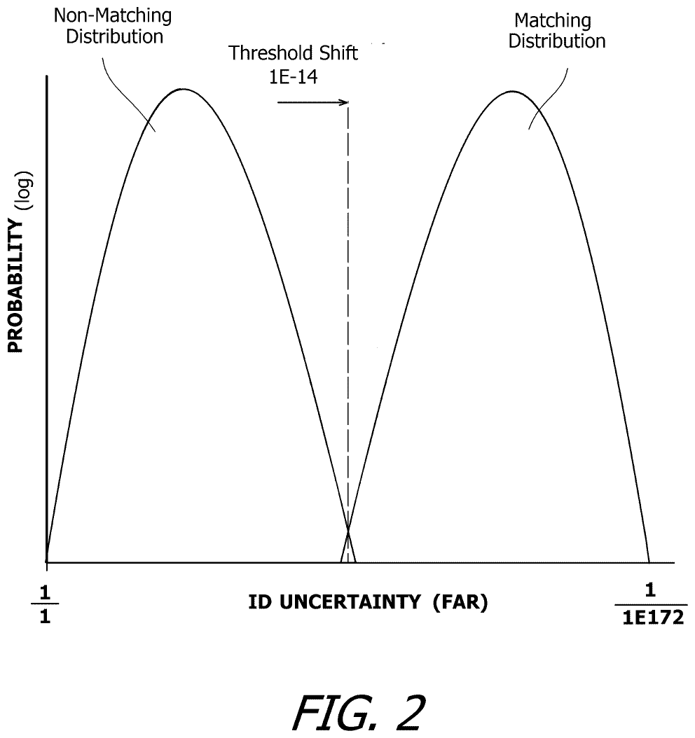

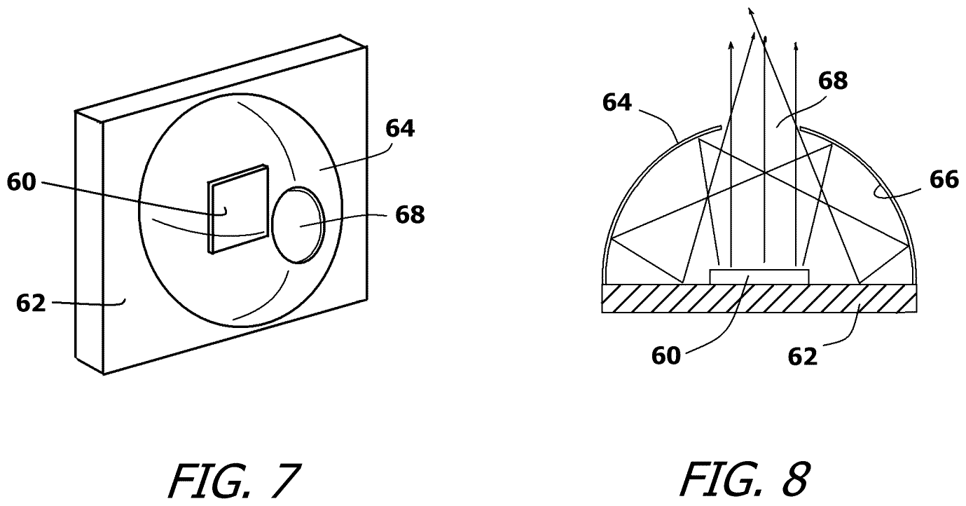

The identification system 10 utilizes an illumination system 15. The illumination system 15 is designed to both reduce the occurrences of eyeglass specularities and make the imaging of vein patterns in the hand 20 possible. Referring to FIG. 7 and FIG. 8 in conjunction with FIG. 1, it can be understood that the illumination system 15 contains at least one, and preferably two, specialized LED 60. The LED 60 emits light in the infrared or near infrared wavelengths. The LED 60 is on a substrate 62 that is partially enclosed by a cover 64. The cover 64 is semicircular in shape and has a reflective interior surface 66. A light exit opening 68 is provided at the apex of the cover 64. The output solid angle of the LED 60 is reduced by the reflective, fitted cover 64. For example, if the LED 60 unmodified beam-forming lens diameter is 2.76 mm while the die itself is approximately one-third the linear size at 0.90 mm, then the reflective coating 66 produces more than a four-fold reduction in illumination source area. This area reduction produces proportionally smaller eyeglasses specularities area sizes and thus reduces iris imaging obscuring effects with eyeglasses. The small light exit opening causes diffraction-induced beam spreading and thus restores the desired wider beam angle for face illumination uniformity. Preferably a pair of the LEDs 60 are utilized that are separated by a distance from the imaging lens 14 so that the LEDs 60 are each at 5 degrees as seen from 24″ (610 mm). This is sufficiently off-axis to avoid so called red-eye that retroreflection illumination brightening of the otherwise dark pupil. Bright pupils are disruptive to the iris segmentation process and iris performance.

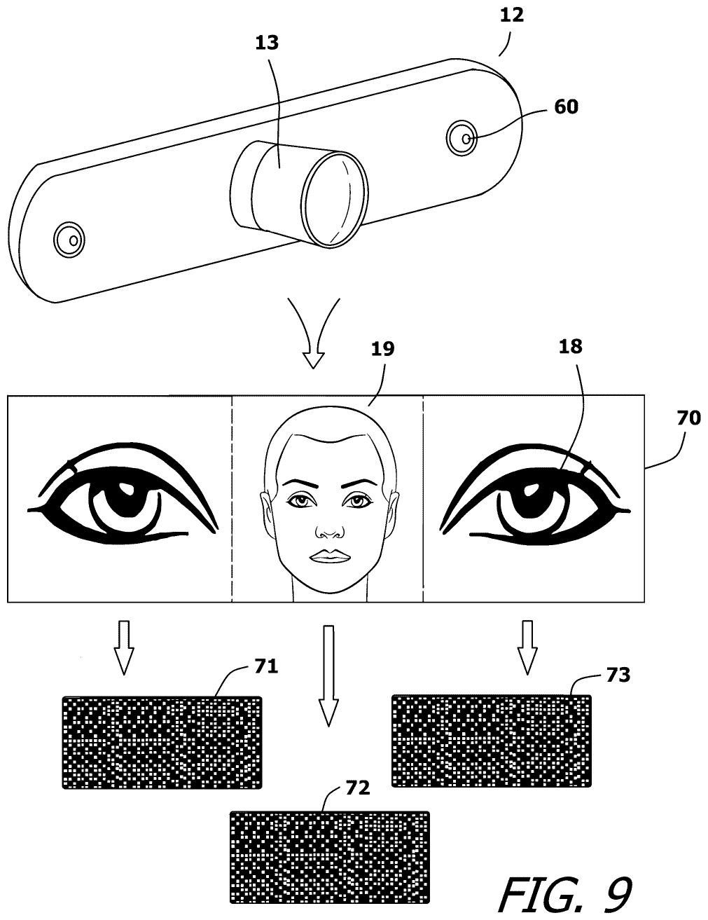

Referring to FIG. 9, an embodiment of the camera assembly 12 is shown. The camera assembly 12 shows the imaging camera 13 and two LEDs 60 of the type previously described. The LEDs 60 are spaced apart and off-axis from the imaging camera 13 to avoid so called red-eye that retroreflection illumination brightening of the otherwise dark pupil.

The camera assembly 12 collects images of facial features 19 and iris patterns 18. Images of the hand can be used if facial features or one of the iris patterns 18 is obscured, or attempted ID fraud is detected. Processed with either an on-premises server or a remote server operating in-the-cloud, the combination of images 70 are digitized or otherwise encoded into biometric templates 71, 72, 73. Biometric templates 71, 72, 73 contain data that provides errorless identity of FAR<1E-20 residual uncertainty probability that the person who was imaged is indeed the person indicated in a database match. Biometric fusion generating errorless ID and is one million times more accurate than even a DNA match, which provides DNA-FAR<1E-14 uncertainty probability and is acknowledged as a gold standard of identity certainty. The biometric templates 71, 72 and 73 can be directly matched to data in a biometric database.

From the above, it will be understood that the identification system can image a person and gather biometric information regarding a person's face, iris patterns, and/or hand. The images are used to gather various sets of biometric data. The multiple sets of biometric data are then used to identify a person, wherein the multiple sets of biometric data produce an ID certainty score that approaches 100% while eliminating nearly all false positives and false negatives. It will be understood that the embodiment of the present invention that is illustrated and described is merely exemplary and that a person skilled in the art can make many variations to that embodiment. All such embodiments are intended to be included within the scope of the present invention as defined by the claims.

What is claimed is:

1. A method of identifying a person using multimodal biometrics, comprising:
providing a camera assembly having a single imaging camera;
imaging a person with said camera assembly to obtain facial features and iris patterns, therein producing a series of camera images;
selecting prime images from said series of camera images that meet a predetermined image quality;
processing said prime images to increase resolution of said prime images and create high-resolution images;
obtaining facial feature data and iris pattern data from said high-resolution images; and
comparing said facial feature data and said iris pattern data to at least one database to identify said person.

2. The method according to claim 1, further including providing an illumination system for illuminating said person as said person is imaged by said camera assembly.

3. The method according to claim 2, wherein said illumination system contains at least one LED that emits light in wavelengths within an infrared and near infrared range.

4. The method according to claim 3, wherein said at least one LED is partially shielded with an internally reflective cover and emits light toward said person through an opening in said internally reflective cover.

5. The method according to claim 1, wherein said camera has a field of view with a central area and a peripheral area that surrounds said central area, wherein said iris patterns are imaged in said central area and said facial features are imaged in said peripheral area.

6. The method according to claim 1, further including imaging a hand of said person to obtain hand feature data and comparing said hand feature data to said at least one database to identify said person.

7. A method of identifying a person using multimodal biometrics, comprising:
providing a camera assembly having a single imaging camera;
imaging a person with said camera assembly to capture multiple biometric features in a series of images, wherein said multiple biometric features are selected from some combination of facial features, iris patterns, and hand features;
processing at least some of said images in said series of images to increase resolution of at least some of said images;
obtaining said biometric data from said images; and
comparing said biometric data to at least one database to identify said person.

8. The method according to claim 7, wherein processing at least some of said images in said series of images includes selecting prime images from said series of images that meet a predetermined image quality.

9. The method according to claim 7, further including providing an illumination system for illuminating said person as said person is imaged by said camera assembly.

10. The method according to claim 9, wherein said illumination system contains at least one LED that emits light in wavelengths within an infrared and near infrared range.

11. The method according to claim 10, wherein said at least one LED is partially shielded with an internally reflective cover and emits light toward said person through on opening in said internally reflective cover.

12. The method according to claim 7, wherein said camera has a field of view with a central area and a peripheral area that surrounds said central area, wherein one of said biometric features is imaged in said central area and another of said biometric features is imaged in said peripheral area.

13. A method of identifying a person, comprising:
Imaging and encoding facial features of said person to create a first encoded biometric template;
imaging and encoding iris patterns of said person to create a second encoded biometric template;
identifying said person by matching said first encoded biometric template and said second encoded biometric template to at least one databases of previously enrolled encoded biometric templates of facial features and iris patterns.

14. The method according to claim 13, further including the step of imaging and encoding hand features of said person.

15. The method according to claim 14, further including analyzing said iris features to determine if said iris features meet a quality standard and substituting said hand features for at least one of said iris features if said at least one of said iris images does not meet said quality standard.

16. The method according to claim 13, wherein said facial features and said iris patterns are imaged using one camera.

17. The method according to claim 16, further including analyzing images of said facial features and said iris features collected by said camera to identify select images that meet predetermined quality standards.

18. The method according to claim 17, further including the step of processing said select images to increase resolution of said select images.
